(19) United States
(12) Patent Application Publication
(10) Pub. No.: US 2006/0022925 A1
(43) Pub. Date: Feb. 2, 2006

(54) Grayscale voltage generation circuit, driver circuit, and electro-optical device

(75) Inventors: Taro Hara, Chino-shi (JP); Masanori Kobayashi, Fujimi-machi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/180,570

(22) Filed: Jul. 14, 2005

(30) Foreign Application Priority Data
Jul. 27, 2004 (JP) 2004-218841

(51) Int. Cl. G09G 3/36

(52) U.S. Cl. 345/89

(57) ABSTRACT

A grayscale voltage generation circuit includes an input-side resistor circuit including first to J-th (J is a positive integer) input voltage division nodes at which the voltage between first and second power supply lines is divided by (J+1) resistor elements connected in series between the first and second power supply lines and having fixed resistance values, first to J-th voltage follower circuits to which the voltages of the first to J-th input voltage division nodes are respectively supplied, an output-side resistor circuit connected between the power supply lines and including first to J-th output voltage division nodes at which the voltage between both ends of the power supply lines is divided, the output voltage division nodes being driven by voltage follower circuits, and a grayscale voltage select circuit which outputs as the grayscale voltages L (J<L<K, L is an integer) types of voltages selected from voltages of K (J<K, K is an integer) resistance division nodes at which the voltage between both ends of the output-side resistor circuit is divided. A voltage of the i-th (1≦i≦J, i is an integer) output voltage division node is equal to a voltage of the i-th input voltage division node.

Japanese Patent Application No. 2004-218841, filed on Jul. 27, 2004, is hereby incorporated by reference in its entirety.

### BACKGROUND OF THE INVENTION

The present invention relates to a grayscale voltage generation circuit, a driver circuit, and an electro-optical device.

In recent years, accompanying wide spread use of an electro-optical device such as a liquid crystal display device, a further improvement of display quality, an increase in definition, and the like have been demanded.

In general, a display device represented by an electro-optical device has its own gamma characteristics. The input (input voltage, input signal, etc.) and the output (grayscale, light transmissivity, brightness, etc.) of the display device do not have a linear proportional relationship, but have an exponential functional relationship. Therefore, in order to allow the input and the output of the display device to have a linear proportional relationship, the input of the display device is corrected while taking the gamma characteristics into consideration so that the display device can express a correct grayscale based on image data.

Among such display devices, a liquid crystal display device is provided in a number of electronic instruments. The liquid crystal display device can be roughly classified into a passive matrix type liquid crystal display device and an active matrix type liquid crystal display device. The passive matrix type liquid crystal display device and the active matrix type liquid crystal display device realize grayscale display using different types of grayscale control.

The passive matrix type liquid crystal display device has the intersecting area of two electrodes oppositely disposed through a liquid crystal as a pixel, and realizes display by matrix control. Therefore, the structure of the passive matrix type liquid crystal display device is simple. However, since it is difficult to perform the grayscale control in pixel units, it is considered difficult to realize an increase in definition and grayscale of an image in comparison with the active matrix type liquid crystal display device.

On the other hand, since the active matrix type liquid crystal display device allows each pixel to be individually controlled by using a switching element such as a thin-film transistor (TFT), an increase in grayscale is easily realized.

A liquid crystal driver circuit (driver circuit in a broad sense) which drives the active matrix type liquid crystal display device is disclosed in JP-A-2003-22062 and JP-A-2003-22063, for example. This liquid crystal driver circuit supplies a gamma-corrected grayscale voltage to a data line of a liquid crystal display device based on image data.

However, the gamma characteristics of the liquid crystal display device may differ not only depending on the liquid crystal material or the like, but also depending on the manufacturing variation or the like even in the same type of products. Therefore, it is preferable that the grayscale voltage be regulated corresponding to the gamma characteristics in order to provide a liquid crystal driver circuit having different gamma characteristics.

In order to prevent deterioration of the image quality, it is necessary for the voltage of the data line to reach the target grayscale voltage within a predetermined write time within one scan period. The number of data lines is increased when increasing the display area of the liquid crystal display device or realizing an increase in definition of the pixels. Therefore, one scan period tends to be reduced within a limited vertical scan period. Therefore, it is necessary to cause the grayscale voltage after gamma correction to promptly reach the target voltage. In order to provide a liquid crystal display device in a portable electronic instrument, it is also necessary to realize a reduction in cost and power consumption.

### SUMMARY

A first aspect of the present invention relates to a grayscale voltage generation circuit for generating a plurality of grayscale voltages, the grayscale voltage generation circuit comprising:

a first resistor circuit including first to (J+1)th (J is a positive integer) resistor elements connected in series between first and second power supply lines, and first to J-th input voltage division nodes at which a voltage between the first and second power supply lines is divided by the first to (J+1)th resistor elements, each of the resistor elements having a fixed resistance value;

first to J-th impedance conversion circuits, voltages of the first to J-th input voltage division nodes being respectively supplied to inputs of the first to J-th impedance conversion circuits;

a second resistor circuit connected between the first and second power supply lines and including first to J-th output voltage division nodes at which the voltage between the first and second power supply lines is divided, the first to J-th output voltage division nodes being respectively driven by the first to J-th impedance conversion circuits; and

a grayscale voltage select circuit which outputs as the grayscale voltages L (J<L<K, L is an integer) types of voltages selected from voltages of first to K-th (J<K, K is an integer) resistance division nodes at which a voltage between both ends of the second resistor circuit is divided, wherein a voltage of the i-th (1≦i≦J, i is an integer) output voltage division node is equal to a voltage of the i-th input voltage division node.

A second aspect of the present invention relates to a driver circuit, comprising:

the above grayscale voltage generation circuit; and

an output circuit which drives an electro-optical device by using one of the grayscale voltages generated by the grayscale voltage generation circuit.

A third aspect of the present invention relates to an electro-optical device comprising the above grayscale voltage generation circuit.

A fourth aspect of the present invention relates to an electronic instrument comprising the above electro-optical device.

### BRIEF DESCRIPTION OF THE SEVERAL VIEWS OF THE DRAWING

FIG. 1 shows a liquid crystal display device in one embodiment of the invention.

FIG. 2 shows another configuration of a liquid crystal display device in one embodiment of the invention.

FIG. 3 is a block diagram showing a power supply circuit shown in FIG. 1.

FIG. 4 is a block diagram showing a data driver shown in FIG. 1.

FIG. 5 is a circuit diagram showing a grayscale voltage generation circuit shown in FIG. 4.

FIG. 6 is a circuit diagram showing an i-th voltage follower circuit.

FIG. 7 is a circuit diagram showing another configuration of a grayscale voltage generation circuit in one embodiment of the invention.

FIG. 8 shows a first select circuit.

FIG. 9 is a graph illustrative of the gamma characteristics of a liquid crystal display device.

FIG. 10 is a timing chart showing a timing example of a power save signal.

FIG. 11 is a graph illustrative of the gamma characteristics of various liquid crystal display devices.

FIG. 12 is a circuit diagram showing a grayscale voltage generation circuit in a first comparative example of one embodiment of the invention.

FIG. 13 is a circuit diagram showing a grayscale voltage generation circuit in a second comparative example of one embodiment of the invention.

FIG. 14 is a circuit diagram showing a grayscale voltage generation circuit in a first modification of one embodiment of the invention.

FIG. 15 is a circuit diagram showing a first select circuit in a second modification of one embodiment of the invention.

FIG. 16 is a timing chart showing a switch control timing of a first switch element and a second switch element shown in FIG. 15.

FIG. 17 is a circuit diagram showing another configuration of a first select circuit.

FIG. 18 shows positive and negative grayscale voltage generation circuits.

FIG. 19 is a block diagram showing an electronic instrument including a display driver to which the grayscale voltage generation circuit in one embodiment of the invention or a first or second modification is applied.

### DETAILED DESCRIPTION OF THE EMBODIMENT

The invention may provide a grayscale voltage generation circuit, a driver circuit, and an electro-optical device capable of stably supplying a grayscale voltage corresponding to various gamma characteristics at reduced cost and power consumption.

An embodiment of the present invention provides a grayscale voltage generation circuit for generating a plurality of grayscale voltages, the grayscale voltage generation circuit comprising:

a first resistor circuit including first to (J+1)th (J is a positive integer) resistor elements connected in series between first and second power supply lines, and first to J-th input voltage division nodes at which a voltage between the first and second power supply lines is divided by the first to (J+1)th resistor elements, each of the resistor elements having a fixed resistance value;

first to J-th impedance conversion circuits, voltages of the first to J-th input voltage division nodes being respectively supplied to inputs of the first to J-th impedance conversion circuits;

a second resistor circuit connected between the first and second power supply lines and including first to J-th output voltage division nodes at which the voltage between the first and second power supply lines is divided, the first to J-th output voltage division nodes being respectively driven by the first to J-th impedance conversion circuits; and

a grayscale voltage select circuit which outputs as the grayscale voltages L (J<L<K, L is an integer) types of voltages selected from voltages of first to K-th (J<K, K is an integer) resistance division nodes at which a voltage between both ends of the second resistor circuit is divided,

wherein a voltage of the i-th (1≦i≦J, i is an integer) output voltage division node is equal to a voltage of the i-th input voltage division node.

In the case of supplying the grayscale voltage to a signal line, a certain period of time is required for the voltage of the signal line to change and reach the target grayscale voltage level. The time required corresponds to the time constant determined by the capacitance component of the signal line and the resistance component of each resistor element of the second resistor circuit. Therefore, it is necessary to cause the voltage of the signal line to reach the target voltage within a predetermined write time while taking the time required into consideration.

According to this embodiment, since the first to J-th impedance conversion circuits respectively drive the first to J-th output voltage division nodes of the second resistor circuit, the target voltage can be promptly reached with a high drive capability in comparison with the case of dividing the voltage between the both ends of the second resistor circuit.

As compared to the case of regulating the grayscale voltage by using a variable resistor as each resistor element of the first resistor circuit and making the input voltage of each impedance conversion circuit variable, the input-side voltage and the output-side voltage of the impedance conversion circuit are equal in this embodiment. Therefore, occurrence of current which flows into or flows from the impedance conversion circuit due to the potential difference between the input-side voltage and the output-side voltage of the impedance conversion circuit can be prevented, differing from the case of using a variable resistor as each resistor element of the first resistor circuit. Therefore, according to this embodiment, current consumption can be reduced to that extent. There may be a case where the phase margin of the impedance conversion circuit is reduced due to occurrence of the current and the impedance conversion circuit easily oscillates. However, according to this embodiment, a state in which the impedance conversion circuit easily oscillates can be prevented.

In addition to the reduction of current consumption, since the impedance conversion circuit does not operate under conditions differing from the design conditions, the design is facilitated, whereby a stable grayscale voltage can be supplied.

With this grayscale voltage generation circuit, the grayscale voltage select circuit may include:

a first select circuit which outputs a first grayscale voltage, which is a voltage closest to a voltage of the first power supply line among the plurality of grayscale voltages, selected from voltages of a plurality of resistance division nodes among the first to K-th resistance division nodes; and

a second select circuit which outputs a second grayscale voltage, which is a voltage closest to a voltage of the second power supply line among the plurality of grayscale voltages, selected from voltages of a plurality of resistance division nodes among the first to K-th resistance division nodes.

In general gamma characteristics, the grayscale and the grayscale voltage have a nonlinear relationship on the high-potential side and the low-potential side. On the other hand, it is unnecessary to regulate the grayscale voltage in the vicinity of the middle of the grayscale voltages (vicinity of intermediate grayscale), since the grayscale and the grayscale voltage have a linear relationship. According to this embodiment, a grayscale voltage generation circuit capable of minimizing an increase in the number of additional circuits and generating the grayscale voltage corresponding to various gamma characteristics can be provided.

With this grayscale voltage generation circuit,

the grayscale voltage select circuit may include a third select circuit which outputs a third grayscale voltage, which is a voltage between the first and second grayscale voltages among the plurality of grayscale voltages, selected from voltages of a plurality of resistance division nodes among the first to K-th resistance division nodes,

a number of the resistance division nodes selected by the first select circuit may be greater than a number of the resistance division nodes selected by the third select circuit, and

a number of the resistance division nodes selected by the second select circuit may be greater than the number of the resistance division nodes selected by the third select circuit.

Only the grayscale voltage groups close to the high-potential side and the low-potential side differ in gamma characteristics to a large extent depending on the type of the display device. Therefore, the grayscale voltage corresponding to various gamma characteristics can be generated using a simple configuration by increasing the number of nodes which can be selected by the select circuit for selecting one grayscale voltage as the grayscale voltage becomes closer to at least one of the high-potential side and the low-potential side.

With this grayscale voltage generation circuit, a voltage difference between the grayscale voltages may be greater as the grayscale voltages become closer to a voltage of the first power supply line.

In general gamma characteristics, a change in the liquid crystal applied voltage corresponding to one grayscale is increased as the grayscale voltage becomes closer to the high-potential side or the low-potential side. According to this embodiment, a grayscale voltage generation circuit capable of minimizing an increase in the number of additional circuits and generating the grayscale voltage corresponding to various gamma characteristics can be provided.

With this grayscale voltage generation circuit, the grayscale voltage select circuit may include:

a plurality of first switch elements, one end of each of the first switch elements being connected with one of the resistance division nodes of the second resistor circuit; and

a second switch element connected at one end with one of the resistance division nodes of the second resistor circuit and having an on-resistance value smaller than an on-resistance value of each of the first switch elements, and

when outputting a fourth grayscale voltage, which is a grayscale voltage among the plurality of grayscale voltages, the second switch element may be turned on and the first switch elements may be turned off to output the fourth grayscale voltage through the second switch element, and then the second switch element may be turned off and one of the first switch elements may be turned on to output the fourth grayscale voltage through the first switch element which has been turned on.

According to this embodiment, since an approximate voltage is output through the second switch element, the target voltage can be reached at higher speed and power consumption can be reduced in comparison with the case of outputting the grayscale voltage through the first switch element having an on-resistance value greater than that of the second switch element.

Moreover, since the second switch element is then turned off and one of the first switch elements is turned on to output the grayscale voltage through the first switch element which has been turned on, the voltage level of the grayscale voltage can be set with high accuracy. This makes it unnecessary to increase the area of all the switch elements in order to decrease the on-resistance values of all the switch elements which form the select circuit. Therefore, the select circuit which can set the grayscale voltage level with high accuracy can be formed using a smaller area.

With this grayscale voltage generation circuit,

the first to J-th impedance conversion circuits may respectively drive the first to J-th output voltage division nodes in a first period within one scan period in which one of the grayscale voltages is supplied to a data line of an electro-optical device, and may stop driving the first to J-th output voltage division nodes in a second period after the first period within the one scan period.

In this embodiment, the input-side voltage and the output-side voltage of the impedance conversion circuit are set to be equal. Therefore, as compared to the case of regulating the grayscale voltage by using a variable resistor as each resistor element of the first resistor circuit and making the input voltage of each impedance conversion circuit variable, the operation of the impedance conversion circuit can be suspended in this embodiment after the target voltage level has been reached. This makes it unnecessary for the impedance conversion circuit to always drive the output voltage division node of the second resistor circuit, whereby current consumption of the impedance conversion circuit during drive can be significantly reduced by preventing an unnecessary operation.

This grayscale voltage generation circuit may comprise:

a first offset resistor circuit connected at one end with one end of the first resistor circuit; and

a second offset resistor circuit connected at one end with one end of the second resistor circuit, and

the first power supply line may be electrically connected with the one end of the first and second offset resistor circuits or the other end of the first and second offset resistor circuits.

According to this embodiment, the grayscale voltages including each grayscale voltage in the intermediate grayscale region having a linear relationship can be more finely adjusted corresponding to the gamma characteristics.

An embodiment of the invention provides a driver circuit comprising:

the above grayscale voltage generation circuit; and

an output circuit which drives an electro-optical device by using one of the grayscale voltages generated by the grayscale voltage generation circuit.

According to this embodiment, a driver circuit including a grayscale voltage generation circuit capable of stably supplying the grayscale voltage corresponding to various gamma characteristics at reduced cost and power consumption can be provided.

An embodiment of the invention provides an electro-optical device comprising the above grayscale voltage generation circuit.

According to this embodiment, an electro-optical device capable of preventing deterioration of the image quality by stably supplying the grayscale voltage corresponding to various gamma characteristics at reduced cost and power consumption can be provided.

An embodiment of the invention provides an electronic instrument comprising the above electro-optical device.

According to this embodiment, an electronic instrument capable of preventing deterioration of the image quality by stably supplying the grayscale voltage corresponding to various gamma characteristics at reduced cost and power consumption can be provided.

Note that the embodiments described hereunder do not in any way limit the scope of the invention defined by the claims laid out herein. Note also that not all of the elements of these embodiments should be taken as essential requirements to the means of the present invention.

The grayscale voltage generation circuit in this embodiment is included in a driver circuit which drives a display device, for example. The driver circuit may be used to drive an electro-optical device of which the optical characteristics are changed by application of voltage, such as a liquid crystal display device.

The following description illustrates the case of applying a grayscale voltage generation circuit in this embodiment to a liquid crystal display device. However, the invention is not limited thereto. The invention may also be applied to other electro-optical devices and display devices.

1. Liquid Crystal Display Device

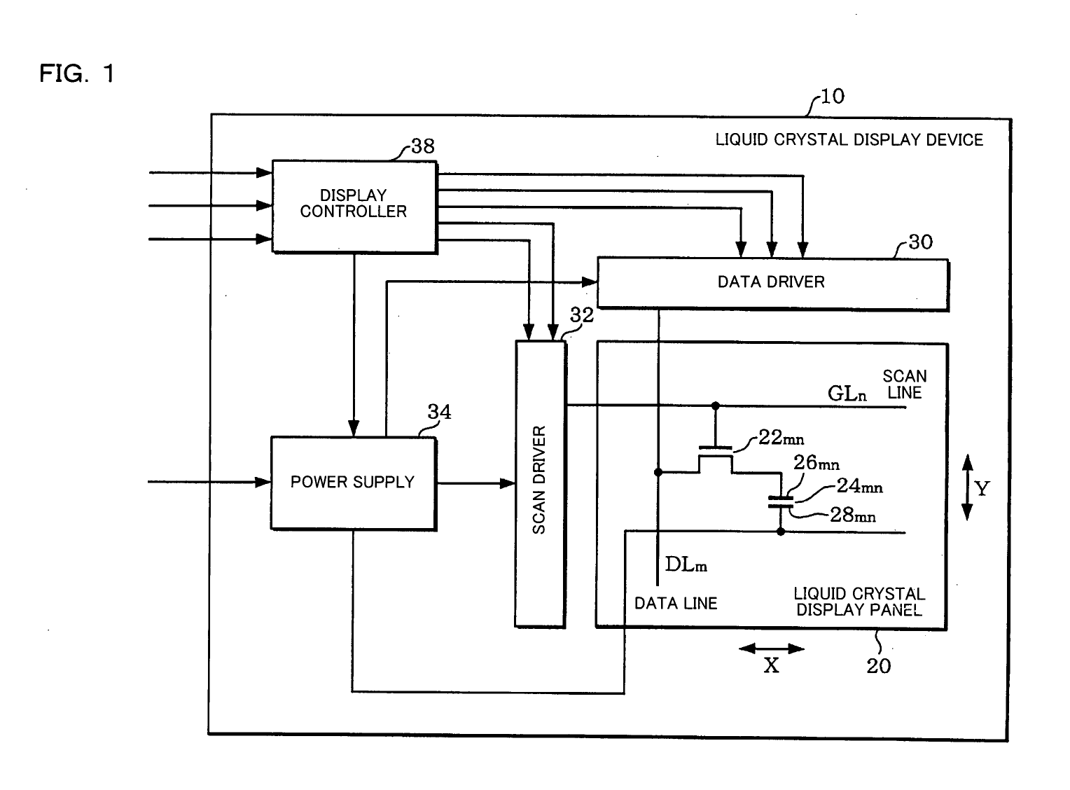

FIG. 1 shows an outline of a configuration of a liquid crystal display device in this embodiment.

A liquid crystal display device (display device or electro-optical device in a broad sense) 10 may include a liquid crystal display panel (display panel in a broad sense) 20.

The liquid crystal display panel 20 is formed on a glass substrate, for example. A plurality of scan lines (gate electrodes or gate lines) GL1 to GLN (N is an integer of two or more), arranged in a direction Y and extending in a direction X, and a plurality of data lines (source electrodes or source lines) DL1 to DLM (M is an integer of two or more), arranged in the direction X and extending in the direction Y, are disposed on the glass substrate. A pixel area (pixel) is provided corresponding to the intersecting point of the scan line GLn (1≦n≦N, n is an integer; hereinafter the same) and the data line DLm (1≦m≦M, m is an integer; hereinafter the same), and a thin-film transistor (hereinafter abbreviated as “TFT”) 22mn is disposed in the pixel area.

A gate electrode of the TFT 22mn is connected with the scan line GLn. A source electrode of the TFT 22mn is connected with the data line DLm. A drain electrode of the TFT 22mn is connected with a pixel electrode 26mn. A liquid crystal is sealed between the pixel electrode 26mn and a common electrode 28mn which faces the pixel electrode 26mn, whereby a liquid crystal capacitor (liquid crystal element in a broad sense) 24mn is formed. The transmissivity of the pixel changes corresponding to the voltage applied between the pixel electrode 26mn and the common electrode 28mn. A common electrode voltage Vcom is supplied to the common electrode 28mn.

The liquid crystal display panel 20 is formed by attaching a first substrate provided with the pixel electrode and the TFT to a second substrate provided with the common electrode, and sealing a liquid crystal as an electro-optical material between the first and second substrates, for example.

The liquid crystal display device 10 may include a data driver (driver circuit or display driver in a broad sense) 30. The data driver 30 drives the data lines DL1 to DLM of the liquid crystal display panel 20 based on image data.

The liquid crystal display device 10 may include a scan driver (driver circuit or display driver in a broad sense) 32. The scan driver 32 scans the scan lines GL1 to GLN of the liquid crystal display panel 20 within one vertical scan period.

The liquid crystal display device 10 may include a power supply circuit 34. The power supply circuit 34 generates a voltage necessary for driving the data lines, and supplies the voltage to the data driver 30. In this embodiment, the power supply circuit 34 generates power supply voltages VDDR and VSS necessary for the data driver 30 to drive the data lines and a voltage necessary for a logic section of the data driver 30.

The power supply circuit 34 generates a voltage necessary for scanning the scan lines, and supplies the voltage to the scan driver 32. In this embodiment, the power supply circuit 34 generates a drive voltage for scanning the scan lines.

The power supply circuit 34 may generate the common electrode voltage Vcom. The power supply circuit 34 outputs the common electrode voltage Vcom, which is periodically changed to a high-potential-side voltage VcomH and a low-potential-side voltage VcomL in synchronization with the timing of a polarity reversal signal POL generated by the data driver 30, to the common electrode of the liquid crystal display panel 20.

The liquid crystal display device 10 may include a display controller 38. The display controller 38 controls the data driver 30, the scan driver 32, and the power supply circuit 34 according to the content set by a host (not shown) such as a central processing unit (CPU). For example, the display controller 38 provides an operation mode setting and a vertical synchronization signal or a horizontal synchronization signal generated therein to the data driver 30 and the scan driver 32.

In FIG. 1, the liquid crystal display device 10 is configured to include the power supply circuit 34 or the display controller 38. However, the liquid crystal display device 10 may be configured so that at least one of the power supply circuit 34 and the display controller 38 is provided outside the liquid crystal display device 10. Or, the liquid crystal display device 10 may be configured to include the host.

The data driver 30 may include at least one of the scan driver 32 and the power supply circuit 34.

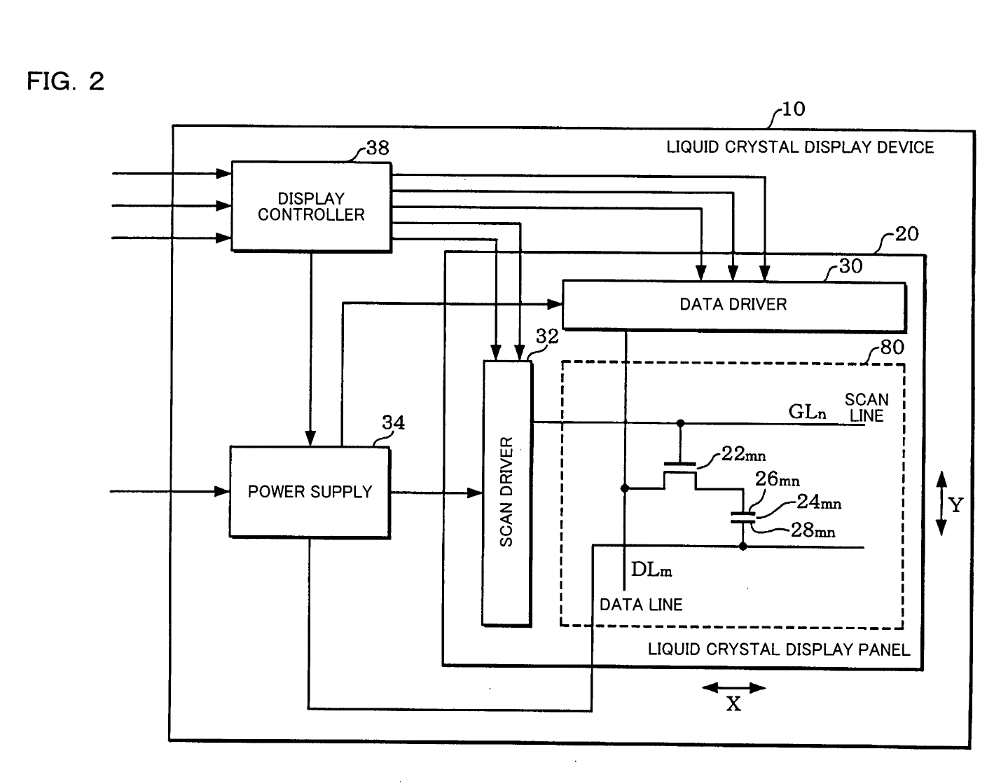

Some or all of the data driver 30, the scan driver 32, the display controller 38, and the power supply circuit 34 may be formed on the liquid crystal display panel 20. In FIG. 2, the data driver 30 and the scan driver 32 are formed on the liquid crystal display panel 20. As described above, the liquid crystal display panel 20 may be configured to include a plurality of data lines, a plurality of scan lines, a plurality of switching elements, each of the switching elements being connected with one of the scan lines and one of the data lines, and a data driver which drives the data lines. A plurality of pixels are formed in a pixel formation region 80 of the liquid crystal display panel 20.

2. Power Supply Circuit

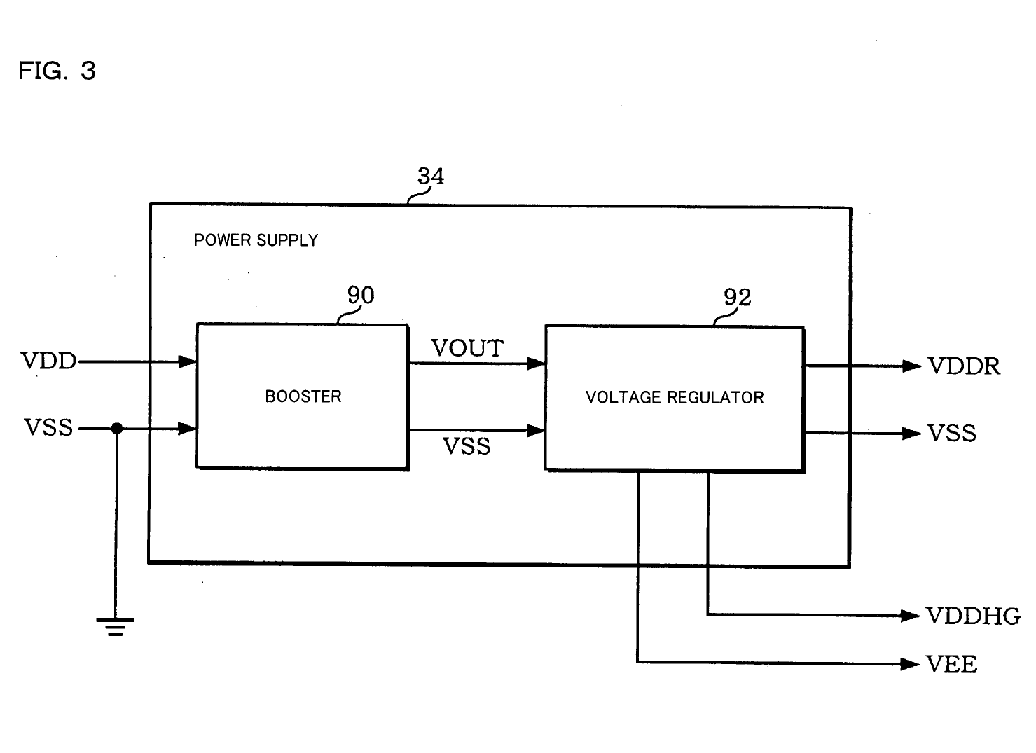

FIG. 3 shows an outline of a configuration of the power supply circuit 34 shown in FIG. 1.

The power supply circuit 34 boosts the voltage difference between a system power supply voltage VDD and a system ground power supply voltage VSS of the liquid crystal display device 10, regulates the boosted voltage, and supplies the resulting voltage to the data driver 30, the scan driver 32, and the like.

The power supply circuit 34 may include a booster circuit 90 and a voltage regulator circuit 92. The booster circuit 90 boosts the system power supply voltage VDD with respect to the system ground power supply voltage VSS, and outputs a boosted voltage VOUT. The voltage regulator circuit 92 regulates the boosted voltage VOUT with respect to the system ground power supply voltage VSS, supplies the voltages VDDR and VSS to the data driver 30 including a grayscale voltage generation circuit, and supplies voltages VDDHG and VEE to the scan driver 32.

The scan driver 32 supplies the voltage VDDHG to the scan line in the select period of the scan line, and supplies the voltage VEE to the scan line in the unselect period of the scan line.

3. Data Driver

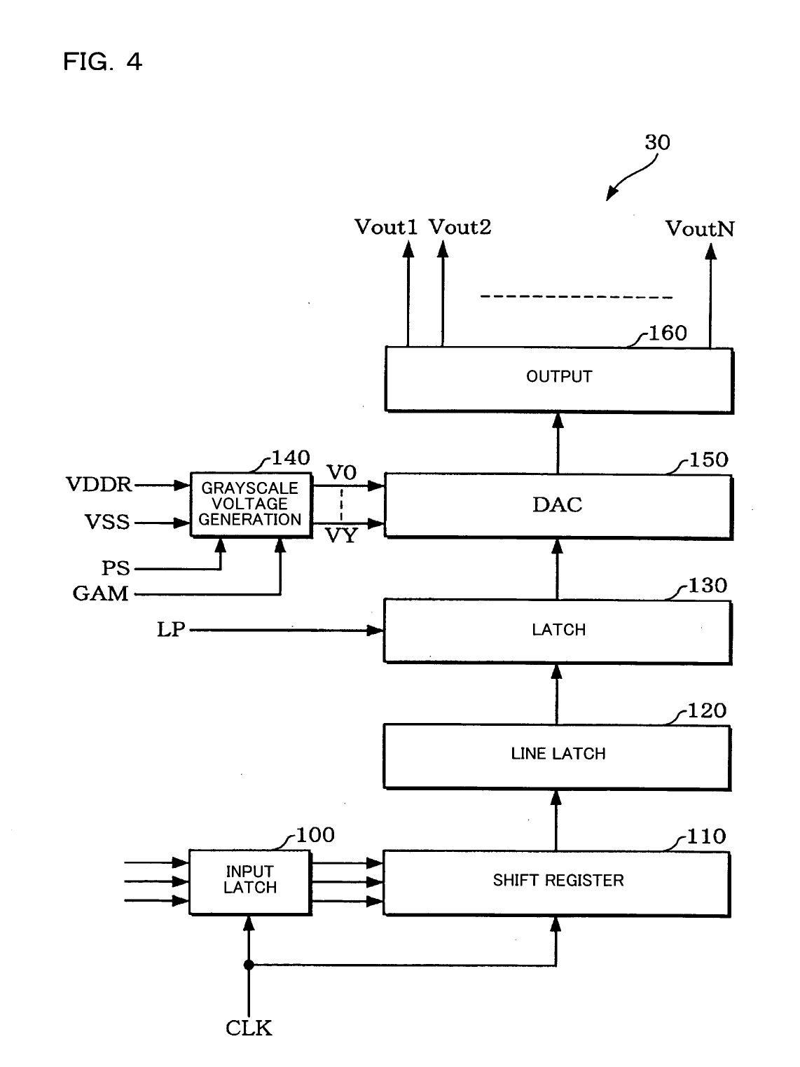

FIG. 4 shows an outline of a configuration of the data driver 30 shown in FIG. 1.

The data driver 30 includes an input latch circuit 100, a shift register 110, a line latch circuit 120, a latch circuit 130, a grayscale voltage generation circuit 140, a digital/analog converter (DAC) 150, and an output circuit 160.

The input latch circuit 100 latches image data serially input in pixel units based on a clock signal CLK. The clock signal CLK is supplied from the display controller 38 shown in FIG. 1. In the case where one pixel is made up of a 6-bit R signal, a 6-bit G signal, and a 6-bit B signal, one pixel is made up of 18 bits.

The shift register 110 shifts the image data latched by the input latch circuit 100 in synchronization with the clock signal CLK. The grayscale data sequentially shifted and held by the shift register 110 is held by the line latch circuit 120. The image data held by the line latch circuit 120 is latched by the latch circuit 130 at the timing of a latch pulse signal LP. The latch pulse signal LP is input from the display controller 38 in a horizontal scan cycle.

The shift register 110 sequentially shifts the image data serially input in pixel units, and the latch circuit 130 holds the image data for one scan line as described above.

The grayscale voltage generation circuit 140 generates a plurality of grayscale voltages V0 to VY (Y is a positive integer) between the high-potential-side power supply voltage (first power supply voltage) VDDR and the low-potential-side power supply voltage (second power supply voltage) VSS from the power supply circuit 34. In the case where each of the R signal, G signal, and B signal is a 6-bit signal, the grayscale voltage generation circuit 140 generates the grayscale voltages V0 to V63 for each color component signal.

The grayscale voltage generation circuit 140 outputs the grayscale voltage gamma-corrected based on a gamma correction control signal GAM. The grayscale voltage generation circuit 140 realizes a low-power-consumption operation through control based on a power save signal PS. The gamma correction control signal GAM is supplied from the display controller 38. The power save signal PS is supplied from a control circuit (not shown) of the data driver 30 or from the display controller 38.

The DAC 150 generates the drive voltage corresponding to the image data output from the latch circuit 130 in units of output lines of the data driver 30. In more detail, in units of image data for one output line from the latch circuit 130, the DAC 150 selects the grayscale voltage corresponding to the image data from the grayscale voltages V0 to V63 generated by the grayscale voltage generation circuit 140, and outputs the selected grayscale voltage as the drive voltage.

The output circuit 160 drives the output lines, each of which is connected with one of the data lines of the liquid crystal display panel 20. In more detail, the output circuit 160 drives each output line based on the drive voltage generated by the DAC 150 in units of output lines. For example, the output circuit 160 drives each output line by using a voltage-follower-connected operational amplifier provided in units of output lines. Specifically, the output circuit 160 drives the liquid crystal display device as an electro-optical device by using one of the grayscale voltages V0 to V63 generated by the grayscale voltage generation circuit 140.

4. Grayscale Voltage Generation Circuit

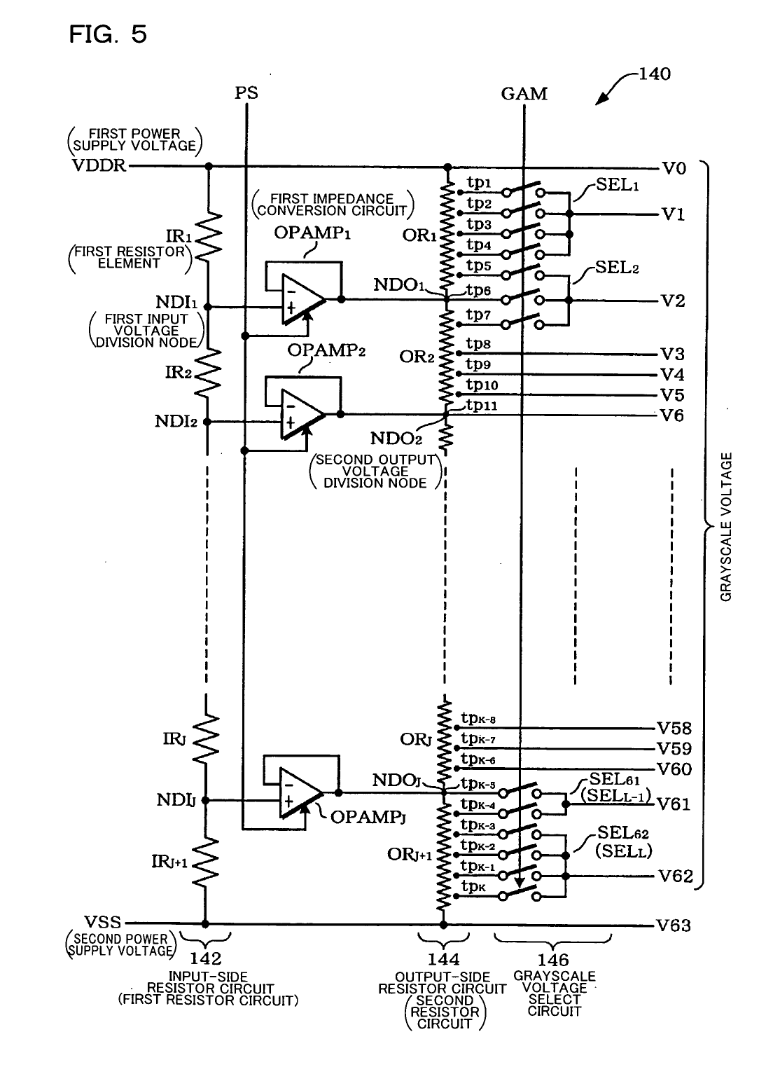

FIG. 5 is a circuit diagram of a configuration example of the grayscale voltage generation circuit 140 shown in FIG. 4. In this embodiment, the grayscale voltage generation circuit 140 generates the grayscale voltages V0 to V63. The grayscale voltage generation circuit 140 outputs the high-potential-side power supply voltage VDDR as the grayscale voltage V0, and outputs the low-potential-side power supply voltage VSS as the grayscale voltage V63.

The grayscale voltage generation circuit 140 includes an input-side resistor circuit (first resistor circuit) 142 and an output-side resistor circuit (second resistor circuit) 144. The input-side resistor circuit 142 and the output-side resistor circuit 144 are connected between the high-potential-side power supply line (first power supply line) and the low-potential-side power supply line (second power supply line). The high-potential-side power supply voltage (first power supply voltage) VDDR is supplied to the high-potential-side power supply line. The low-potential-side power supply voltage (second power supply voltage) VSS is supplied to the low-potential-side power supply line. Therefore, the input-side resistor circuit 142 and the output-side resistor circuit 144 are connected between the high-potential-side power supply voltage VDDR and the low-potential-side power supply voltage VSS.

The input-side resistor circuit 142 includes first to J-th input voltage division nodes NDI₁ to NDI_{J} at which the voltage between the both ends of the input-side resistor circuit 142 is divided by (J+1) (J is a positive integer). In more detail, the input-side resistor circuit 142 includes first to (J+1)th input-side resistor elements IR₁ to IR_{J+1} connected in series between the high-potential-side power supply line and the low-potential-side power supply line (high-potential-side power supply voltage VDDR and low-potential-side power supply voltage VSS). The first to (J+1)th input-side resistor elements IR₁ to IR_{J+1} are fixed resistors having fixed resistance values. The voltage between the high-potential-side power supply voltage VDDR and the low-potential-side power supply voltage VSS is divided by the first to (J+1)th input-side resistor elements IR₁ to IR_{J+1}. The i-th input voltage division node NDIᵢ (1≦i≦J, i is an integer) is a node connected with the i-th input-side resistor element IRᵢ and the (i+1)th input-side resistor element IRᵢ₊₁.

The output-side resistor circuit 144 includes first to J-th output voltage division nodes NDO₁ to NDO_{J} at which the voltage between the both ends of the output-side resistor circuit 144 is divided by (J+1). In more detail, the output-side resistor circuit 144 includes first to (J+1)th output-side resistor elements OR₁ to OR_{J+1} connected in series between the high-potential-side power supply line and the low-potential-side power supply line (high-potential-side power supply voltage VDDR and low-potential-side power supply voltage VSS). The first to (J+1)th output-side resistor elements OR₁ to OR_{J+1} are fixed resistors having fixed resistance values. The voltage between the high-potential-side power supply voltage VDDR and the low-potential-side power supply voltage VSS is divided by the first to (J+1)th output-side resistor elements OR₁ to OR_{J+1}. The i-th output voltage division node NDOᵢ is a node connected with the i-th output-side resistor element ORᵢ and the (i+1)th output-side resistor element ORᵢ₊₁.

The voltage is divided by using each input-side resistor element and each output-side resistor element so that the voltage of the i-th input voltage division node NDIᵢ is equal to the voltage of the i-th output voltage division node NDOᵢ.

An i-th voltage follower circuit (i-th impedance conversion circuit) OPAMPᵢ is provided between the i-th input voltage division node NDIᵢ and the i-th output voltage division node NDOᵢ corresponding to the i-th input voltage division node NDIᵢ. The i-th voltage follower circuit OPAMPᵢ includes a voltage-follower-connected differential amplifier, and functions as an impedance conversion circuit. The voltage of the i-th input voltage division node NDIᵢ is supplied to the input of the i-th voltage follower circuit OPAMPᵢ. The output of the i-th voltage follower circuit OPAMPᵢ is connected with the i-th output voltage division node NDOᵢ. Therefore, the i-th voltage follower circuit OPAMPᵢ drives the i-th output voltage division node NDOᵢ based on the voltage of the i-th input voltage division node NDIᵢ.

The first to J-th voltage follower circuits OPAMP₁ to OPAMP_{J} are drive-controlled based on the power save signal PS. In more detail, the first to J-th voltage follower circuits OPAMP₁ to OPAMP_{J} are driven in a drive period designated by the power save signal PS, and drive of the output of the first to J-th voltage follower circuits OPAMP₁ to OPAMP_{J} is suspended in a non-drive period designated by the power save signal PS.

The grayscale voltage generation circuit 140 includes a grayscale voltage select circuit 146. The grayscale voltage select circuit 146 selects L (J<L<K, L is an integer) types of voltages as the grayscale voltages from voltages of first to K-th resistance division nodes tp₁ to tp_{K} obtained by dividing the voltage between the both ends of the output-side resistor circuit 146 by (K+1) (J<K, K is an integer). In the case where the grayscale voltage generation circuit 140 generates the grayscale voltages V0 to V63, the grayscale voltage generation circuit 140 outputs 62 types of voltages excluding the grayscale voltages V0 and V63 as the grayscale voltages V1 to V62. The grayscale voltage select circuit 146 selects L resistance division nodes from the first to K-th resistance division nodes tp₁ to tp_{K} based on the gamma correction control signal GAM, and outputs the voltages of the selected L resistance division nodes as the grayscale voltages.

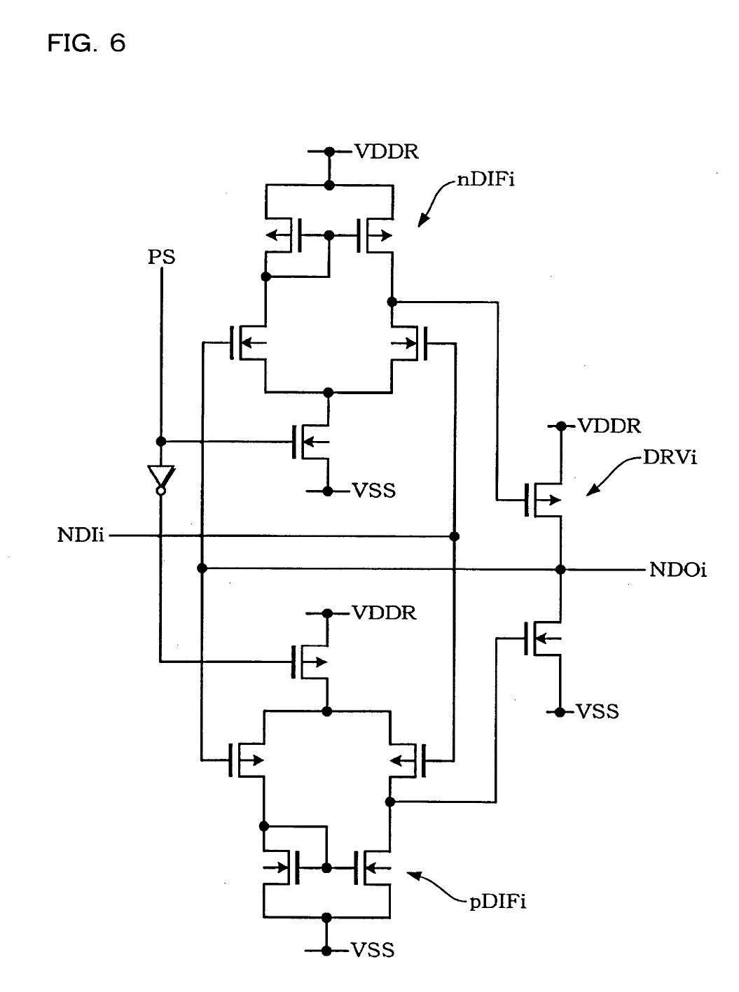

FIG. 6 is a circuit diagram of a configuration example of the i-th voltage follower circuit OPAMPᵢ. FIG. 6 illustrates a configuration example of the i-th voltage follower circuit OPAMPᵢ. However, the configurations of the first to (i−1)th voltage follower circuits OPAMP₁ to OPAMPᵢ₋₁ and the (i+1)th to J-th voltage follower circuits OPAMPᵢ₊₁ to OPAMP_{J} are the same as that of the i-th voltage follower circuit OPAMPᵢ.

The i-th voltage follower circuit OPAMPᵢ includes a p-type differential amplifier section pDIFᵢ, an n-type differential amplifier section nDIFᵢ, and a drive section DRVᵢ. The p-type differential amplifier section pDIFᵢ includes a transistor which forms a current source, and the operation of the p-type differential amplifier section pDIFᵢ or suspension of the operation can be controlled by supplying the power save signal PS to a gate electrode of the transistor. The n-type differential amplifier section nDIFᵢ includes a transistor which forms a current source, and the operation of the n-type differential amplifier section nDIFᵢ or suspension of the operation can be controlled by supplying the power save signal PS to a gate electrode of the transistor.

Since such a configuration of the i-th voltage follower circuit OPAMPi is known in the art, description of the detailed operation is omitted. In this embodiment, when the power save signal PS is set at the H level, the p-type differential amplifier section pDIFᵢ supplies a gate voltage of an n-type driver transistor of the drive section DRVᵢ so that the voltage of the i-th input voltage division node NDIᵢ is equal to the voltage of the i-th output voltage division node NDOᵢ. When the power save signal PS is set at the L level, the operation of the current source of the p-type differential amplifier section pDIFᵢ is suspended, whereby the operation of the p-type differential amplifier section pDIFᵢ stops.

When the power save signal PS is set at the H level, the n-type differential amplifier section nDIFᵢ supplies a gate voltage of a p-type driver transistor of the drive section DRVᵢ so that the voltage of the i-th input voltage division node NDIᵢ is equal to the voltage of the i-th output voltage division node NDOᵢ. When the power save signal PS is set at the L level, the operation of the current source of the n-type differential amplifier section nDIFᵢ is suspended, whereby the operation of the n-type differential amplifier section nDIFᵢ stops.

Therefore, when the power save signal PS is set at the H level, the i-th voltage follower circuit OPAMPᵢ drives the i-th output voltage division node NDOᵢ based on the voltage of the i-th input voltage division node NDIᵢ. When the power save signal PS is set at the L level, the i-th voltage follower circuit OPAMPᵢ stops driving the i-th output voltage division node NDOᵢ. Since the operations of the current sources of the p-type differential amplifier section pDIFᵢ and the n-type differential amplifier section nDIFᵢ can be suspended when the power save signal PS is set at the L level, current consumption can be reduced.

It should be understood that the configuration of the voltage follower circuit as the impedance conversion circuit is not limited to the configuration shown in FIG. 6.

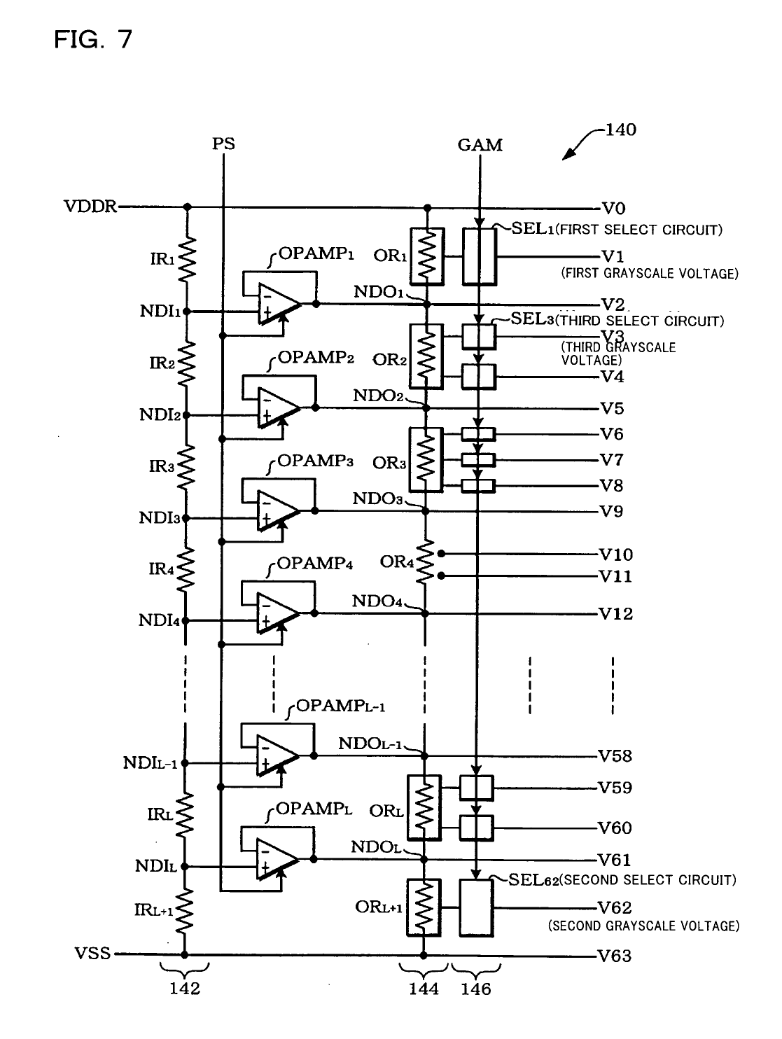

FIG. 7 is a diagram of another configuration example of the grayscale voltage generation circuit 140 in this embodiment. In FIG. 7, sections the same as the sections of the grayscale voltage generation circuit 140 shown in FIG. 5 are indicated by the same symbols, and description of these sections is appropriately omitted.

In FIG. 7, it is preferable that the grayscale voltage select circuit 146 include at least a first select circuit SEL₁ for selecting the grayscale voltage closest to the high-potential-side power supply voltage VDDR (voltage of the first power supply line), and a second select circuit SEL₂ for selecting the grayscale voltage closest to the low-potential-side power supply voltage VSS (voltage of the second power supply line). In more detail, the first select circuit SEL₁ outputs the grayscale voltage V1 (first grayscale voltage) among the grayscale voltages V0 to V63 closest to the high-potential-side power supply voltage VDDR selected from the voltages of the resistance division nodes among the first to K-th resistance division nodes tp₁ to tp_{K}. The second select circuit SEL₂ outputs the grayscale voltage V62 (second grayscale voltage) among the grayscale voltages V0 to V63 closest to the low-potential-side power supply voltage VSS selected from the voltages of the resistance division nodes among the first to K-th resistance division nodes tp₁ to tp_{K}.

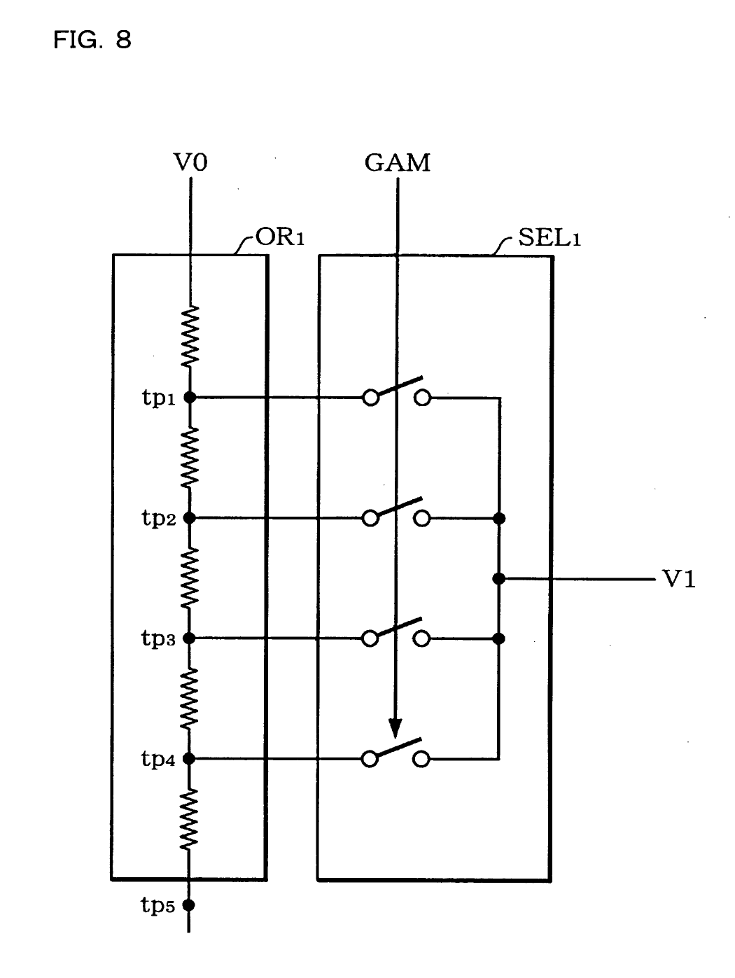

FIG. 8 shows a configuration example of the first select circuit SEL₁. FIG. 8 illustrates a configuration example of the first select circuit SEL₁. However, the second select circuit SEL₂ also has the same configuration.

In FIG. 8, the first select circuit SEL₁ selects one of the voltages of the first to fourth resistance division nodes tp₁to tp₄ based on the gamma correction control signal GAM. In FIG. 8, one voltage is selected from the voltages of four resistance division nodes. However, the invention is not limited thereto.

The select circuit is provided for each output-side resistor element in a number of zero, one, or two or more.

The operation of the grayscale voltage generation circuit 140 shown in FIG. 5 or FIG. 7 is described below.

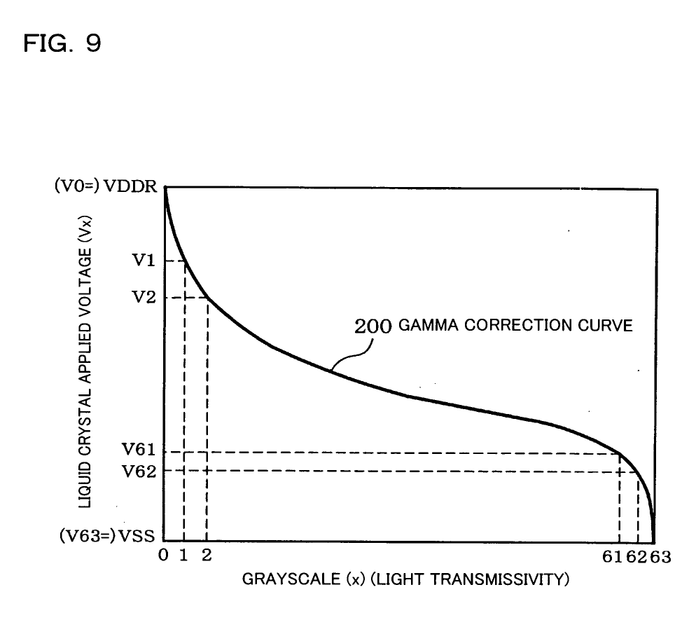

FIG. 9 shows the gamma characteristics (liquid-crystal light transmissivity characteristics) of a liquid crystal display device.

In FIG. 9, the horizontal axis indicates the grayscale (x) which indicates the display brightness, and the vertical axis indicates the liquid crystal applied voltage (Vx). The grayscale (x) may be expressed by 6-bit image data, for example. In this case, the grayscale is “0” when the image data is “000000”, and the grayscale is “61” when the image data is “111101”.

In FIG. 9, a gamma correction curve 200 indicates gamma characteristics of a normally-white active matrix type liquid crystal display device. As indicated by the gamma correction curve 200, the relationship between the grayscale (x) and the liquid crystal applied voltage (Vx) is a nonlinear relationship. Therefore, it is necessary to supply a gamma-corrected applied voltage to the liquid crystal in order to faithfully express an image based on image data.

In the case of driving an active matrix type liquid crystal display device having the gamma correction curve 200 shown in FIG. 9, the grayscale voltage generation circuit 140 generates the grayscale voltages associated with the grayscales “0” to “63” according to the gamma correction curve 200. In the case where the liquid crystal driver circuit performs display at a grayscale of “2”, the grayscale voltage generation circuit 140 selects the grayscale voltage “V2” from the grayscale voltages “V0” to “V63” generated, and supplies the grayscale voltage “V2” to the data line. In the case where the liquid crystal driver circuit performs display at a grayscale of “61”, the grayscale voltage generation circuit 140 selects the grayscale voltage “V61” from the grayscale voltages “V0” to “V63” generated, and supplies the grayscale voltage “V61” to the data line.

In this case, a delay time corresponding to the time constant determined by the capacitance component of each signal line and the resistance component of each resistor element of the output-side resistor circuit 144 is required for the voltage of each signal line to change and reach the target voltage. This means that a certain period of time is required for each grayscale voltage to reach the target voltage even if the supply of the high-potential-side power supply voltage VDDR and the low-potential-side power supply voltage VSS commences, such as in the case where the data driver 30 performs a polarity reversal drive or the supply of power commences. Therefore, it is necessary to cause the voltage of the signal line to reach the target voltage within a predetermined write time while taking the delay time into consideration.

In this embodiment, the first to J-th voltage follower circuits OPAMP₁ to OPAMP_{J} respectively drive the first to J-th output voltage division nodes NDO₁ to NDO_{J}. Therefore, the target voltage can be promptly reached with a high drive capability in comparison with the case of dividing the voltage between both ends of the output-side resistor circuit 144. This enables the target voltage to be promptly reached even if the number of data lines is increased due to an increase in the display area of the liquid crystal display device or an increase in definition of the pixels to reduce one horizontal scan period, whereby a stable grayscale voltage can be supplied.

It is preferable that the first to J-th voltage follower circuits OPAMP₁ to OPAMP_{J} simultaneously stop the operation based on the power save signal PS. In more detail, the first to J-th voltage follower circuits OPAMP₁ to OPAMP_{J} respectively drive the first to J-th output voltage division nodes NDO₁ to NDO_{J} in the voltage follower circuit drive period (first period) within one scan period in which one of the grayscale voltages V0 to V63 is supplied to the data lines DL1 to DLM. In the voltage follower circuit non-drive period (second period) after the voltage follower circuit drive period within the scan period, the first to J-th voltage follower circuits OPAMP₁ to OPAMP_{J} stop driving the first to J-th output voltage division nodes NDO₁ to NDO_{J}.

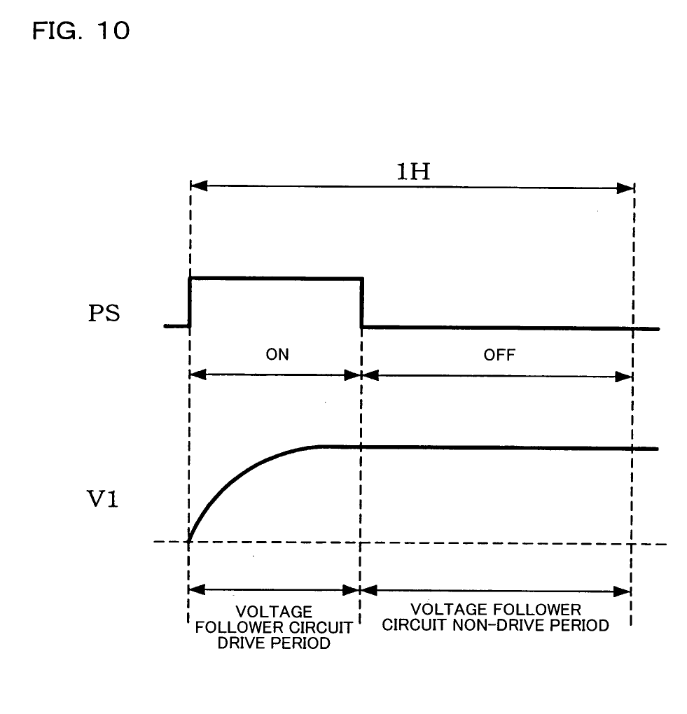

FIG. 10 shows a timing example of the power save signal PS. FIG. 10 illustrates only changes in the power save signal PS and the grayscale voltage V1. However, the same description also applies to the grayscale voltages V2 to V62.

The power save signal PS is set at the H level in the first half of the 1H period (one line scan period) as the voltage follower circuit drive period. This causes the current sources of the first to J-th voltage follower circuits OPAMP₁ to OPAMP_{J} to operate, whereby the first to J-th voltage follower circuits OPAMP₁ to OPAMP_{J} respectively drive the first to J-th output voltage division nodes NDO₁ to NDO_{J}. Therefore, the grayscale voltage V₁ promptly reaches the target voltage in comparison with the case of dividing the voltage using resistor elements and outputting the divided voltage.

The power save signal PS is set at the L level in the latter half of the 1H period as the voltage follower circuit non-drive period. This causes the operations of the current sources of the first to J-th voltage follower circuits OPAMP₁ to OPAMP_{J} to be suspended. Therefore, the voltage level divided by the resistor elements of the output-side resistor circuit 144 is maintained in the voltage follower circuit non-drive period. Since the target voltage level has been reached in the voltage follower circuit drive period, the level of the grayscale voltage can be maintained even if the operations of the current sources of the first to J-th voltage follower circuits OPAMP₁ to OPAMP_{J} are suspended in the voltage follower circuit non-drive period. Therefore, power consumption can be reduced without causing a change in the level of each grayscale voltage.

Consider the case of generating the grayscale voltages optimum for liquid crystal display devices A and B.

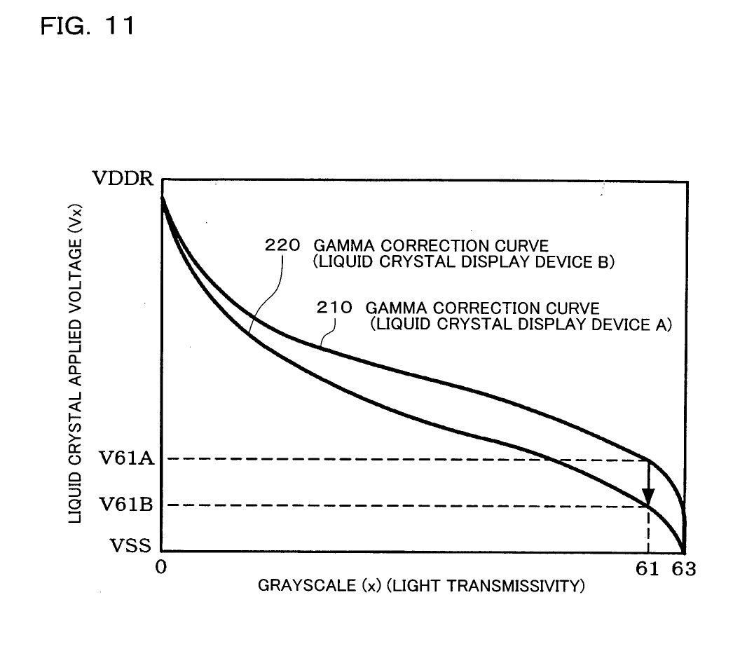

FIG. 11 shows the gamma characteristics of the liquid crystal display devices A and B.

In this case, it is necessary to generate a grayscale voltage “V61A” when driving the liquid crystal display device A and generate a grayscale voltage “V61B” when driving the liquid crystal display device B corresponding to the grayscale “61”, for example.

However, according to this embodiment, since it suffices to select an optimum resistance division node from the resistance division nodes based on the gamma correction control signal GAM, the grayscale voltage corresponding to various gamma characteristics can be stably supplied.

As shown in FIG. 11, the gamma characteristics of the liquid crystal display device differ depending on the product, manufacturing variation, and the like. However, only the grayscale voltage group close to the high-potential-side power supply voltage VDDR and the grayscale voltage group close to the low-potential-side power supply voltage VSS differ to a large extent. This is because it is unnecessary to regulate the grayscale voltage in the vicinity of the middle of the grayscale voltages (vicinity of intermediate grayscale) since the grayscale and the grayscale voltage have a linear relationship. Therefore, as shown in FIG. 11, it suffices that the grayscale voltages close to the high-potential-side power supply voltage VDDR and the low-potential-side power supply voltage VSS, such as the grayscale voltages V1 to V8 and V59 to V62, can be regulated. Therefore, it is preferable that at least the grayscale voltages V1 and V62 closest to the high-potential-side power supply voltage VDDR and the low-potential-side power supply voltage VSS can be regulated. This enables provision of a grayscale voltage generation circuit capable of minimizing an increase in the number of additional circuits and generating the grayscale voltage corresponding to various gamma characteristics.

In this embodiment, it is preferable that the grayscale voltage select circuit 146 include a third select circuit SEL₃ which outputs the grayscale voltage between the grayscale voltages V1 and V62 (first and second grayscale voltages) among the grayscale voltages V0 to V63, such as the grayscale voltage V3 (third grayscale voltage). The third select circuit SEL₃ outputs the grayscale voltage V3 (third grayscale voltage) between the grayscale voltages V1 and V62 (first and second grayscale voltages) selected from the voltages of the resistance division nodes among the first to K-th resistance division nodes tp₁to tp_{K}. In this case, the number of resistance division nodes selected by the first select circuit SEL₁ is greater than the number of resistance division nodes selected by the third select circuit SEL₃. The number of resistance division nodes selected by the second select circuit SEL₂ is greater than the number of resistance division nodes selected by the third select circuit SEL₃.

As described above, only the grayscale voltage group close to the high-potential-side power supply voltage VDDR and the grayscale voltage group close to the low-potential-side power supply voltage VSS differ in gamma characteristics to a large extent. Therefore, the grayscale voltage corresponding to various gamma characteristics can be generated using a simple configuration by increasing the number of nodes which can be selected by the select circuit for selecting one grayscale voltage as the grayscale voltage becomes closer to the high-potential-side power supply voltage VDDR or the low-potential-side power supply voltage VSS.

It is preferable that the voltage difference between the grayscale voltages be greater as the grayscale voltage becomes closer to the high-potential-side power supply voltage VDDR (first power supply voltage) or the low-potential-side power supply voltage VSS (second power supply voltage). This is because the change in the liquid crystal applied voltage corresponding to one grayscale becomes greater as the grayscale voltage becomes closer to the high-potential-side power supply voltage VDDR (first power supply voltage) or the low-potential-side power supply voltage VSS (second power supply voltage), as shown in FIG. 9 or FIG. 11. This also enables the grayscale voltage corresponding to various gamma characteristics to be generated using a simple configuration.

4.1 Comparative Example

The grayscale voltage generation circuit 140 in this embodiment is described below by comparison with a comparative example of this embodiment.

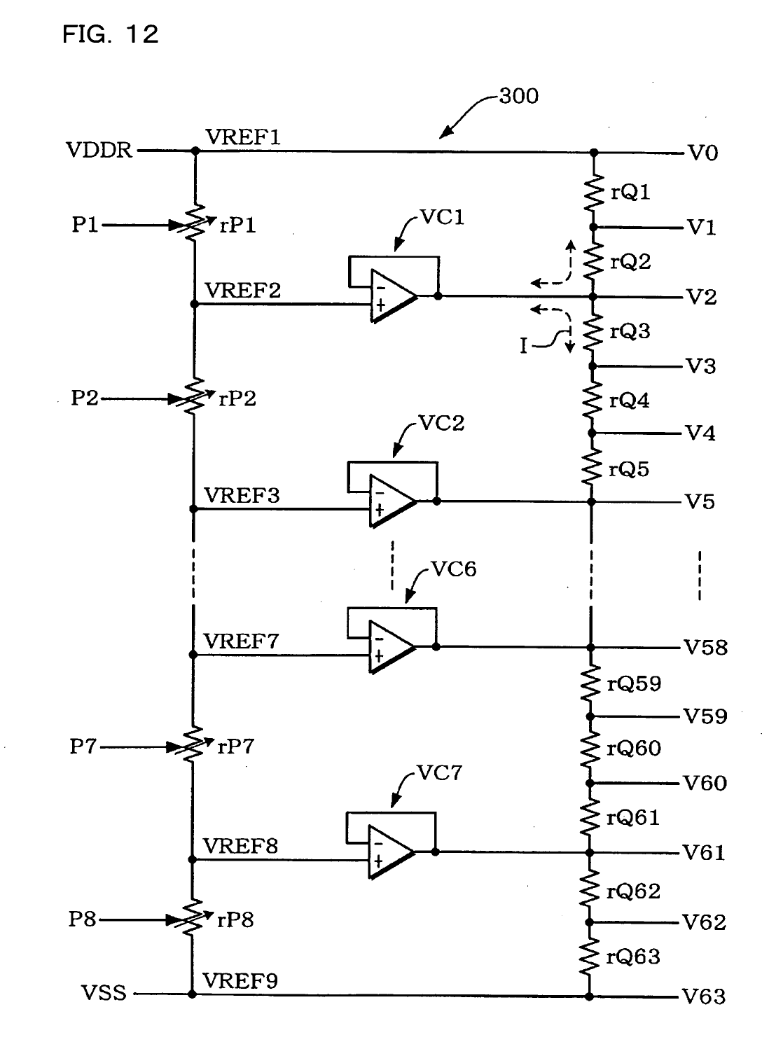

FIG. 12 shows a configuration example of a grayscale voltage generation circuit 300 in a first comparative example of this embodiment. In FIG. 12, sections the same as the sections of the grayscale voltage generation circuit 140 in this embodiment shown in FIG. 5 or FIG. 7 are indicated by the same symbols, and description of these sections is appropriately omitted.

The grayscale voltage generation circuit 300 in the first comparative example generates reference grayscale voltages VREF1 to VREF9 from the input voltage difference (¦VDDR−VSS¦). The grayscale voltage generation circuit 300 generates the grayscale voltages V0 to V63 from the difference between the reference grayscale voltages (¦VREF1−VREF2¦, etc.).

In the grayscale voltage generation circuit 300, gamma correction resistors rP1 to rP8 are connected in series between the high-potential-side power supply line and the low-potential-side power supply line. Gamma correction resistors rQ1 to rQ63 are connected in series between the high-potential-side power supply line and the low-potential-side power supply line. The high-potential-side power supply voltage VDDR is supplied to the high-potential-side power supply line. The low-potential-side power supply voltage VSS is supplied to the low-potential-side power supply line.

The gamma correction resistors rP1 to rP8 are variable resistors, and the gamma correction resistors rQ1 to rQ63 are fixed resistors. The resistance values of the gamma correction resistors rP1 to rP8 are adjusted by using correction signals P1 to P8.

Voltage follower circuits VC1 to VC7 are respectively connected between the connection nodes of the gamma correction resistors rP1 to rP8 and the grayscale voltage generation nodes corresponding to the connection nodes.

The default resistance values of the gamma correction resistors rP1 to rP8 and the default resistance values of the gamma correction resistors rQ1 to rQ63 are determined corresponding to the gamma characteristics of a liquid crystal display device. The default resistance values of the gamma correction resistors rP1 to rP8 and the default resistance values of the gamma correction resistors rQ1 to rQ63 are determined so that the resistance value between the reference grayscale voltages is equal on the input side and the output side of the gamma correction resistors. For example, (default resistance value of gamma correction resistor rP1) equals the sum of (resistance value of gamma correction resistor qQ1) and (resistance value of gamma correction resistor rQ2) between the reference grayscale voltages VREF1 and VREF2.

Suppose that the default resistance values are determined for the liquid crystal display device A shown in FIG. 11. In the case of generating the grayscale voltage corresponding to the gamma characteristics of the liquid crystal display device B, the resistance values of the gamma correction resistors rP1 to rP8 are changed by using the correction signals to change the grayscale voltage from “V61A” to “V61B”, for example.

However, a potential difference occurs between the input side and the output side of each voltage follower circuit, whereby current flows between the output-side gamma correction resistor and the voltage follower circuit. Specifically, since the input-side gamma correction resistance ratio is changed by changing the gamma correction resistor rP1, for example, (resistance value of gamma correction resistor rP1 after change) becomes smaller than the sum of (resistance value of gamma correction resistor rQ1) and (resistance value of gamma correction resistor rQ2), or (resistance value of gamma correction resistor rP1 after change) becomes greater than the sum of (resistance value of gamma correction resistor rQ1) and (resistance value of gamma correction resistor rQ2), whereby a potential difference occurs between the input side and the output side of the voltage follower circuit VC1. As a result, current I occurs.

There may be a case where the phase margin of the voltage follower circuit is reduced due to occurrence of the current I. In this case, the voltage follower circuit easily oscillates. As a result, a stable grayscale voltage cannot be supplied. Moreover, power consumption is increased due to occurrence of the current I. Furthermore, since the voltage follower circuit operates under conditions differing from the design conditions, the voltage follower circuit further easily oscillates.

On the other hand, since the resistance values of all the input-side resistor elements are fixed in the grayscale voltage generation circuit 140 in this embodiment, the gamma characteristics are adjusted by changing the resistance values of the output-side resistor elements. Therefore, the potentials of the input side and the output side of each voltage follower circuit are always equal. This prevents occurrence of the current I as in the grayscale voltage generation circuit 300 in the first comparative example. Current consumption can be reduced by preventing occurrence of the current I, and oscillation of the voltage follower circuit can be prevented.

Moreover, since the potentials of the input side and the output side of each voltage follower circuit are always equal, the operation of the voltage follower circuit can be suspended after the target voltage level has been reached, as shown in FIG. 10. In the first comparative example, since the voltage follower circuit must always drive its output, the operation of the voltage follower circuit cannot be suspended. As described above, according to this embodiment, power consumption can be significantly reduced in comparison with the first comparative example.

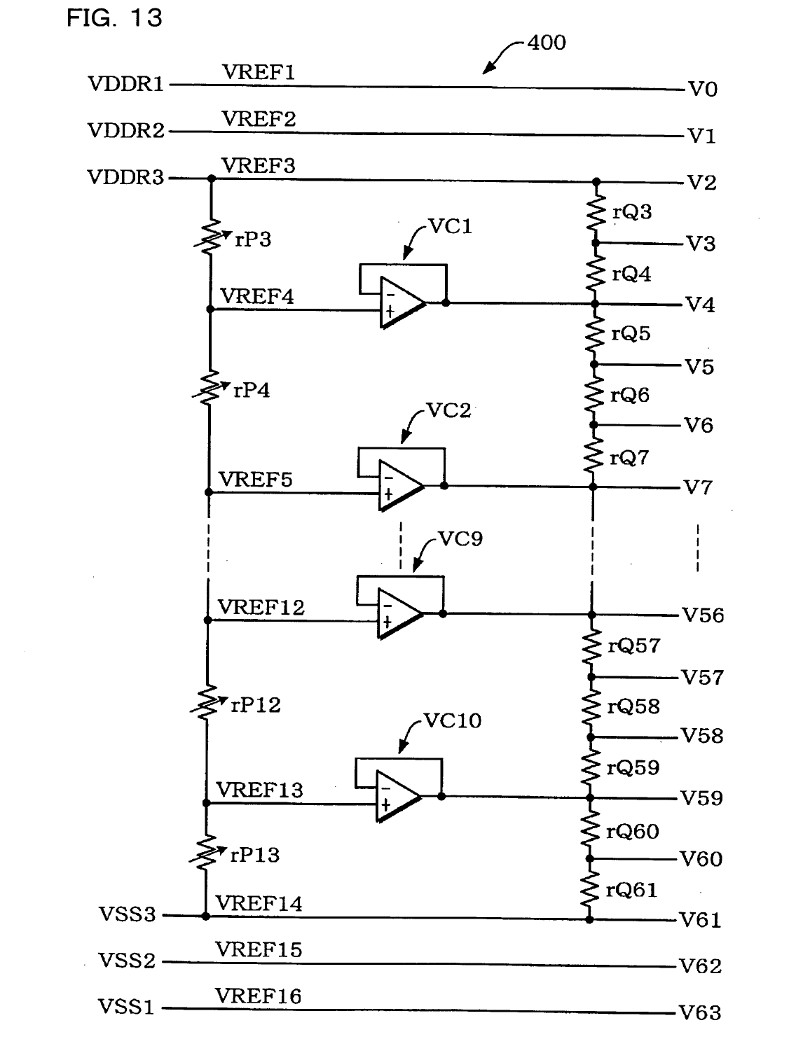

FIG. 13 shows a configuration example of a grayscale voltage generation circuit 400 in a second comparative example of this embodiment. In FIG. 13, sections the same as the sections of the grayscale voltage generation circuit 300 in the first comparative example shown in FIG. 12 are indicated by the same symbols, and description of these sections is appropriately omitted.

The essential difference between the grayscale voltage generation circuit 400 in the second comparative example and the grayscale voltage generation circuit 300 in the first comparative example is that the grayscale voltage generation circuit 400 directly generates the grayscale voltages V0, V1, V62, and V63 by using a power supply circuit. In this power supply circuit, the grayscale voltages V0, V1, V62, and V63 are regulated by using an electronic volume or the like.

However, since the power supply circuit must generate a greater number of power supply voltages, cost is increased due to an increase in the number of additional circuits, an increase in the layout area, and the like. Moreover, since the gamma correction resistor is also adjusted on the input side of the voltage follower circuit in the second comparative example, a problem similar to that of the first comparative example occurs.

Therefore, since the grayscale voltage generation circuit 140 in this embodiment enables the power supply circuit which supplies the power supply voltage to the grayscale voltage generation circuit 140 to be simplified in comparison with the second comparative example, a reduction in cost can be realized. Moreover, according to this embodiment, the grayscale voltage corresponding to various gamma characteristics can be stably supplied at reduced power consumption as described above.

It should be understood that the invention is not limited to the above-described configuration.

4.2 Modification

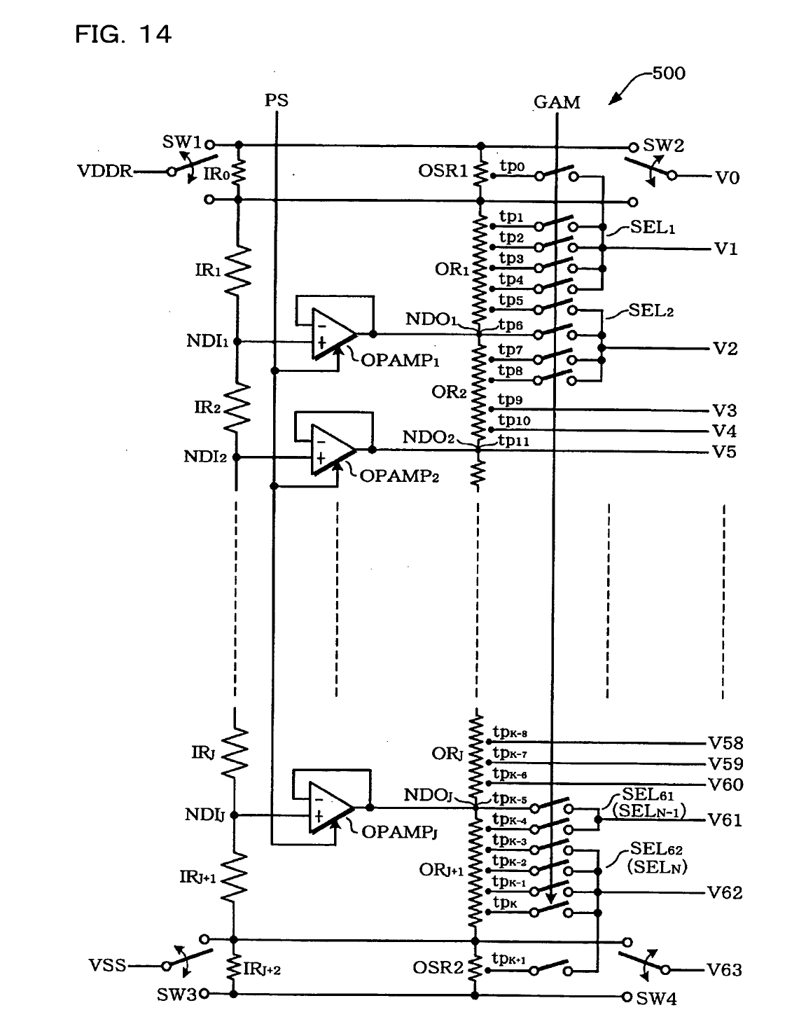

FIG. 14 is a circuit diagram of a configuration example of a grayscale voltage generation circuit 500 in a first modification of this embodiment. In FIG. 14, sections the same as the sections of the grayscale voltage generation circuit 140 in this embodiment shown in FIG. 5 are indicated by the same symbols, and description of these sections is appropriately omitted.

The grayscale voltage generation circuit 500 in the first modification further includes input-side offset resistor circuits (first offset resistor circuits) IR₀ and IR_{J+2} and output-side offset resistor circuits (second offset resistor circuits) OSR1 and OSR2. The input-side offset resistor circuit IR₀ is connected with one end of the input-side resistor circuit (first resistor circuit). The output-side offset resistor circuit OSR1 is connected with one end of the output-side resistor circuit (second resistor circuit). The input-side offset resistor circuit IR_{J+2} is connected with one end of the input-side resistor circuit (first resistor circuit). The output-side offset resistor circuit OSR2 is connected with the other end of the output-side resistor circuit (second resistor circuit). The resistance ratio of the input-side resistor circuit including the input-side offset resistor circuits and the resistance ratio of the output-side resistor circuit including the output-side offset resistor circuits are set so that the input voltage and the output voltage of the i-th voltage follower circuit (i-th impedance conversion circuit) OPAMPᵢ become equal.

The high-potential-side power supply line is electrically connected with either one end or the other end of the input-side offset resistor circuit IR₀ and the output-side offset resistor circuit OSR1. Specifically, the high-potential-side power supply voltage VDDR (first power supply voltage) is supplied to either one end or the other end of the input-side offset resistor circuit IR₀ and the output-side offset resistor circuit OSR1. Therefore, the high-potential-side power supply voltage VDDR is directly supplied to one end of the input-side resistor circuit 142 and the output-side resistor circuit 144, or the high-potential-side power supply voltage VDDR is supplied to one end of the input-side resistor circuit 142 and the output-side resistor circuit 144 respectively through the input-side offset resistor circuit IR₀ and the output-side offset resistor circuit OSR1. In this case, it is preferable that the high-potential-side power supply voltage VDDR be continuously supplied as the grayscale voltage V0 by switching switch circuits SW1 and SW2 using a single control signal.

The low-potential-side power supply line is electrically connected with either one end or the other end of the input-side offset resistor circuit IR_{J+2} and the output-side offset resistor circuit OSR2. Specifically, the low-potential-side power supply voltage VSS (second power supply voltage) is supplied to either one end or the other end of the input-side offset resistor circuit IR_{J+2} and the output-side offset resistor circuit OSR2. Therefore, the low-potential-side power supply voltage VSS is directly supplied to the other end of the input-side resistor circuit 142 and the output-side resistor circuit 144, or the low-potential-side power supply voltage VSS is supplied to the other end of the input-side resistor circuit 142 and the output-side resistor circuit 144 respectively through the input-side offset resistor circuit IR_{J+2} and the output-side offset resistor circuit OSR2. In this case, it is preferable that the low-potential-side power supply voltage VSS be continuously supplied as the grayscale voltage V63 by switching switch circuits SW3 and SW4 using a single control signal.

According to the first modification, the grayscale voltages including each grayscale voltage in the intermediate grayscale region having a linear relationship can be more finely adjusted corresponding to the gamma characteristics.

In FIG. 14, the switch circuits SW1 and SW2 are provided on the high-potential side and the switch circuits SW3 and SW4 are provided on the low-potential side. However, the invention is not limited thereto. For example, the switch circuits may be provided on at least one of the high-potential side and the low-potential side.

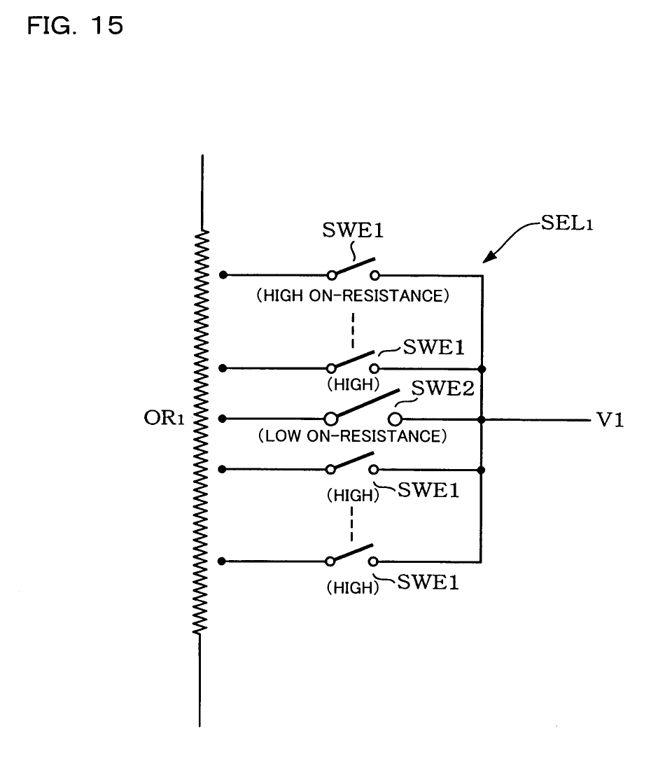

FIG. 15 is a circuit diagram of a configuration example of the first select circuit SEL₁ in a second modification of this embodiment. In FIG. 15, sections the same as the sections of the first select circuit SEL₁ in this embodiment shown in FIG. 8 are indicated by the same symbols, and description of these sections is appropriately omitted.

The first select circuit SEL₁ in the second modification may be applied as each select circuit which forms the grayscale voltage select circuit in this embodiment or the first modification.

The first select circuit SEL₁ (grayscale voltage select circuit in a broad sense) in the second modification includes a plurality of first switch elements SWE1 and one second switch element SWE2. One end of each of the first switch elements SWE1 is connected with one of the resistance division nodes of the output-side resistor circuit 144 (second resistor circuit). Each of the first switch elements SWE1 has the same configuration.

One end of the second switch element SWE2 is connected with one of the resistance division nodes of the output-side resistor circuit 144 (second resistor circuit). The on-resistance value of the second switch element SWE2 is smaller than the on-resistance value of each of the first switch elements. The on-resistance value used herein refers to the resistance value when the switch element is set in an on state (conducting state).

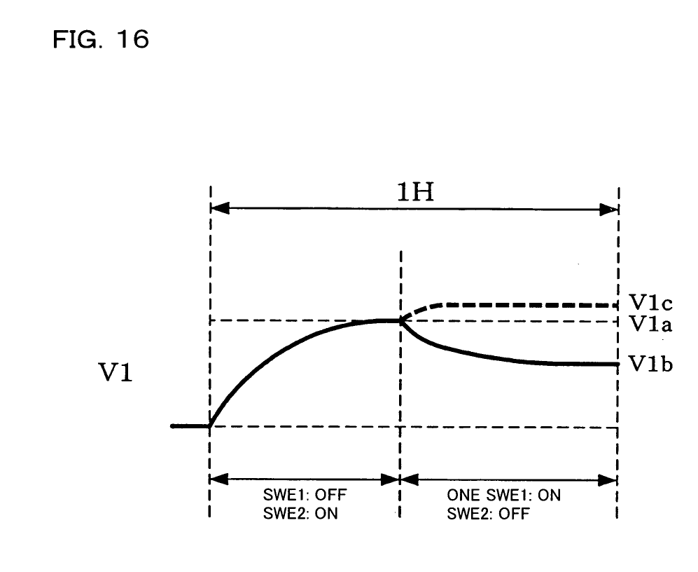

FIG. 16 is a timing diagram showing switch control of the first switch elements SWE1 and the second switch element SWE2.

In the case of outputting one of the grayscale voltages V0 to V63 (grayscale voltage V1 (fourth grayscale voltage) in FIG. 15), the second switch element SWE2 is turned on and all of the first switch elements SWE1 are turned off to output the grayscale voltage V1 (fourth grayscale voltage) through the second switch element SWE2. This enables the grayscale voltage V1 to be set at an approximate voltage level through the switch element having a lower on-resistance value. In this case, the target voltage can be reached at higher speed and power consumption is reduced in comparison with the case of outputting the grayscale voltage through the first switch element SWE1.

The second switch element SWE2 is then turned off and one of the first switch elements SWE1 is turned on to output the grayscale voltage V1 (fourth grayscale voltage) through the first switch element which has been turned on. This enables the voltage level of the grayscale voltage V1 to be set with high accuracy.

The above-described configuration makes it unnecessary to increase the area of all the switch elements in order to decrease the on-resistance values of all the switch elements which form the first select circuit SEL₁. Therefore, the first select circuit SEL₁ which can set the grayscale voltage level with high accuracy can be formed using a smaller area.

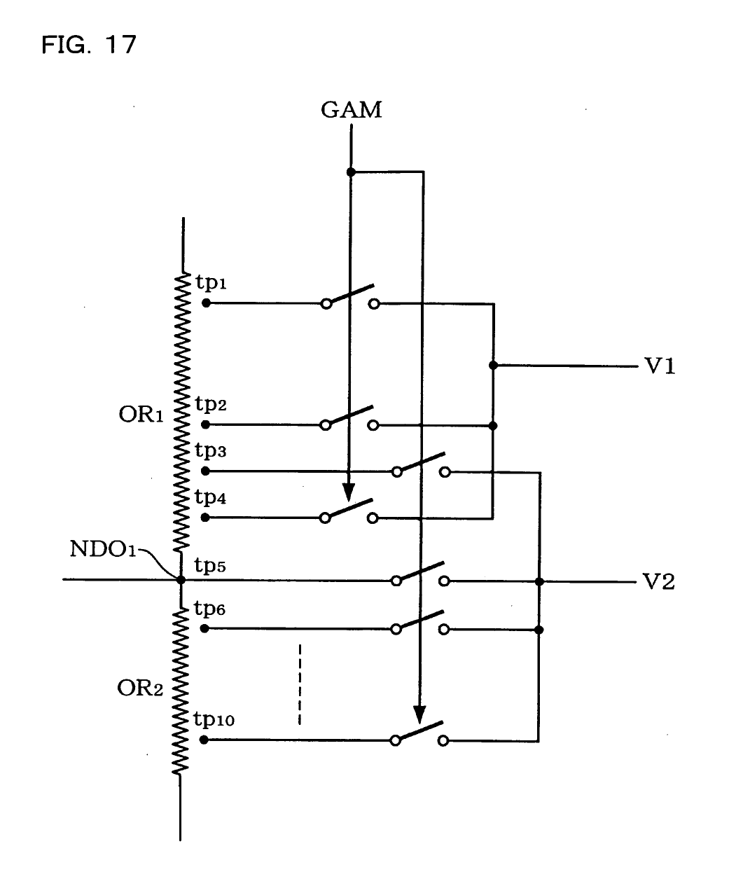

Moreover, the grayscale voltage is not unnecessarily generated from the voltages of one or more resistance division nodes in the order from the high-potential side, differing from this embodiment or the first or second modification. For example, as shown in FIG. 17, the voltage of the fourth resistance division node tp₄ for selecting the grayscale voltage V1 may be lower than the voltage of the third resistance division node tp₃ for selecting the grayscale voltage V2. In this case, the grayscale voltages V1 and V2 must be selected from the voltages of the resistance division nodes by using the gamma correction control signal GAM so that the potential of the grayscale voltage V1 is higher than the potential of the grayscale voltage V2.

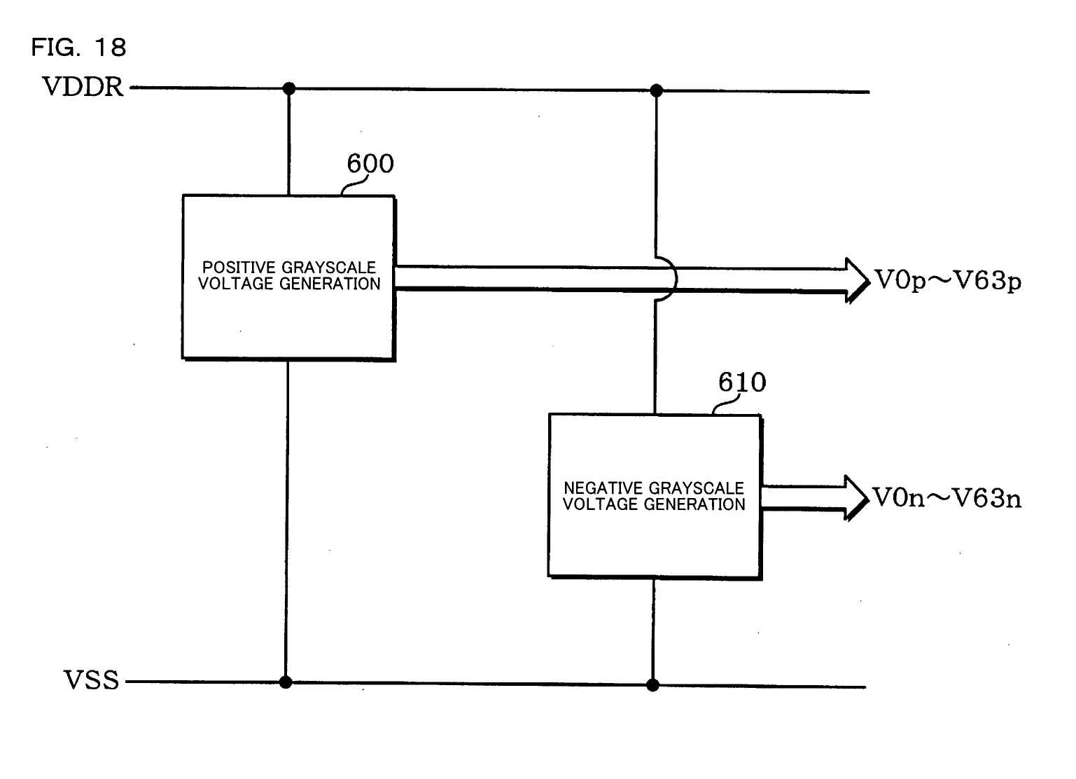

In the case of performing a polarity reversal drive for alternating the liquid crystal applied voltage, positive and negative grayscale voltage generation circuits may be provided, as shown in FIG. 18.

FIG. 18 shows a configuration example in the case of providing positive and negative grayscale voltage generation circuits.

A positive grayscale voltage generation circuit 600 generates grayscale voltages V0p to V63p used in a period in which the liquid crystal applied voltage is positive. A negative grayscale voltage generation circuit 610 generates grayscale voltages V0n to V63n used in a period in which the liquid crystal applied voltage is negative. The DAC selects one of the grayscale voltages V0p to V63p in the positive period, and selects one of the grayscale voltages V0n to V63n in the negative period.

The positive grayscale voltage generation circuit 600 and the negative grayscale voltage generation circuit 610 are provided between the high-potential-side power supply line and the low-potential-side power supply line. The grayscale voltage generation circuit in this embodiment or the first or second modification is applied as the positive grayscale voltage generation circuit 600 and the negative grayscale voltage generation circuit 610.

5. Electronic Instrument

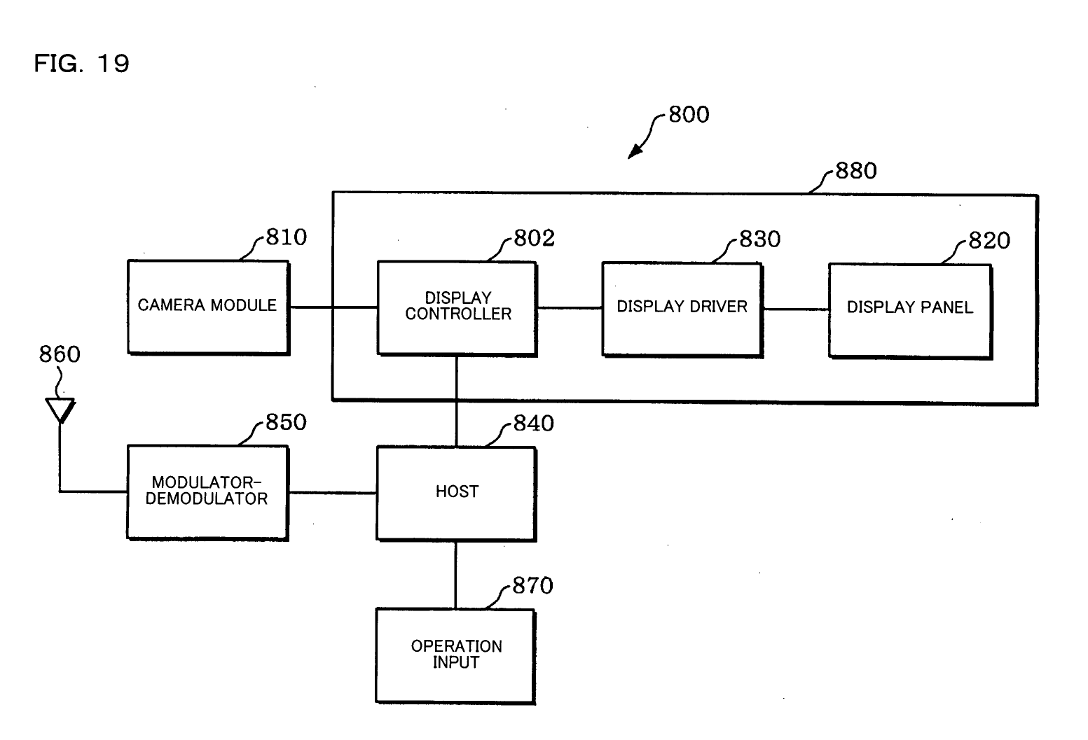

FIG. 19 is a block diagram of a configuration example of an electronic instrument to which a driver circuit including the above-described grayscale voltage generation circuit is applied. FIG. 19 is a block diagram of a configuration example of a portable telephone as an electronic instrument.

A portable telephone 800 includes a camera module 810. The camera module 810 includes a CCD camera, and supplies data on an image imaged by using the CCD camera to a display controller 802. The display controller 38 shown in FIG. 1 may be employed as the display controller 802.

The portable telephone 800 includes a display panel 820. The liquid crystal display panel 20 shown in FIG. 1 may be employed as the display panel 820. In this case, the display panel 820 is driven by a display driver 830. The display panel 820 includes a plurality of scan lines, a plurality of data lines, and a plurality of pixels. The display driver 830 has a function of a scan driver which selects the scan lines in units of one or more scan lines, and a function of a data driver which supplies a voltage corresponding to image data to the data lines. The functions of the display driver 830 may be realized by a data driver including the grayscale voltage generation circuit in this embodiment or the first or second modification and the scan driver 32 shown in FIG. 1.

The display controller 802 is connected with the display driver 830, and supplies image data to the display driver 830.

A host 840 is connected with the display controller 802. The host 840 controls the display controller 802. The host 840 demodulates image data received through an antenna 860 using a modulator-demodulator section 850, and supplies the demodulated image data to the display controller 802. The display controller 802 causes the display driver 830 to display an image on the display panel 820 based on the image data.

The host 840 modulates the image data generated by the camera module 810 using the modulator-demodulator section 850, and directs transmission of the modulated data to another communication device through the antenna 860.

The host 840 performs image data transmission/reception processing, imaging using the camera module 810, and display processing of the display panel based on operational information from an operation input section 870.

A liquid crystal display device 880 as an electro-optical device may include the display controller 802, the display driver 830, and the display panel 820. In this case, the host 840 supplies image data to the liquid crystal display device 880.

The invention is not limited to the above-described embodiment. Various modifications and variations may be made within the spirit and scope of the invention. For example, the invention may be applied not only to drive the above-described liquid crystal display panel, but also to drive an electroluminescence or plasma display device.

Part of requirements of any claim of the present invention could be omitted from a dependent claim which depends on that claim. Moreover, part of requirements of any independent claim of the present invention could be made to depend on any other independent claim.

Although only some embodiments of the present invention have been described in detail above, those skilled in the art will readily appreciate that many modifications are possible in the embodiments without materially departing from the novel teachings and advantages of this invention. Accordingly, all such modifications are intended to be included within scope of this invention.

What is claimed is:

1. A grayscale voltage generation circuit for generating a plurality of grayscale voltages, the grayscale voltage generation circuit comprising:
a first resistor circuit including first to (J+1)th (J is a positive integer) resistor elements connected in series between first and second power supply lines, and first to J-th input voltage division nodes at which a voltage between the first and second power supply lines is divided by the first to (J+1)th resistor elements, each of the resistor elements having a fixed resistance value;
first to J-th impedance conversion circuits, voltages of the first to J-th input voltage division nodes being respectively supplied to inputs of the first to J-th impedance conversion circuits;
a second resistor circuit connected between the first and second power supply lines and including first to J-th output voltage division nodes at which the voltage between the first and second power supply lines is divided, the first to J-th output voltage division nodes being respectively driven by the first to J-th impedance conversion circuits; and
a grayscale voltage select circuit which outputs as the grayscale voltages L (J<L<K, L is an integer) types of voltages selected from voltages of first to K-th (J<K, K is an integer) resistance division nodes at which a voltage between both ends of the second resistor circuit is divided,
wherein a voltage of the i-th (1≦i≦J, i is an integer) output voltage division node is equal to a voltage of the i-th input voltage division node.

2. The grayscale voltage generation circuit as defined in claim 1,
wherein the grayscale voltage select circuit includes:
a first select circuit which outputs a first grayscale voltage, which is a voltage closest to a voltage of the first power supply line among the plurality of grayscale voltages, selected from voltages of a plurality of resistance division nodes among the first to K-th resistance division nodes; and
a second select circuit which outputs a second grayscale voltage, which is a voltage closest to a voltage of the second power supply line among the plurality of grayscale voltages, selected from voltages of a plurality of resistance division nodes among the first to K-th resistance division nodes.

3. The grayscale voltage generation circuit as defined in claim 2,
wherein the grayscale voltage select circuit includes a third select circuit which outputs a third grayscale voltage, which is a voltage between the first and second grayscale voltages among the plurality of grayscale voltages, selected from voltages of a plurality of resistance division nodes among the first to K-th resistance division nodes,
wherein a number of the resistance division nodes selected by the first select circuit is greater than a number of the resistance division nodes selected by the third select circuit, and
wherein a number of the resistance division nodes selected by the second select circuit is greater than the number of the resistance division nodes selected by the third select circuit.

4. The grayscale voltage generation circuit as defined in claim 1,
wherein a voltage difference between the grayscale voltages is greater as the grayscale voltages become closer to a voltage of the first power supply line.

5. The grayscale voltage generation circuit as defined in claim 1,
wherein the grayscale voltage select circuit includes:
a plurality of first switch elements, one end of each of the first switch elements being connected with one of the resistance division nodes of the second resistor circuit; and
a second switch element connected at one end with one of the resistance division nodes of the second resistor circuit and having an on-resistance value smaller than an on-resistance value of each of the first switch elements, and
wherein, when outputting a fourth grayscale voltage, which is a grayscale voltage among the plurality of grayscale voltages, the second switch element is turned on and the first switch elements are turned off to output the fourth grayscale voltage through the second switch element, and then the second switch element is turned off and one of the first switch elements is turned on to output the fourth grayscale voltage through the first switch element which has been turned on.

6. The grayscale voltage generation circuit as defined in claim 1,
wherein the first to J-th impedance conversion circuits respectively drive the first to J-th output voltage division nodes in a first period within one scan period in which one of the grayscale voltages is supplied to a data line of an electro-optical device, and stop driving the first to J-th output voltage division nodes in a second period after the first period within the one scan period.

7. The grayscale voltage generation circuit as defined in claim 1, comprising:
a first offset resistor circuit connected at one end with one end of the first resistor circuit; and
a second offset resistor circuit connected at one end with one end of the second resistor circuit,
wherein the first power supply line is electrically connected with the one end of the first and second offset resistor circuits or the other end of the first and second offset resistor circuits.

8. A driver circuit, comprising:
the grayscale voltage generation circuit as defined in claim 1; and
an output circuit which drives an electro-optical device by using one of the grayscale voltages generated by the grayscale voltage generation circuit.

9. An electro-optical device comprising the grayscale voltage generation circuit defined in claim 1.

10. An electronic instrument comprising the electro-optical device defined in claim 9.
